(19) United States
(12) Patent Application Publication
(10) Pub. No.: US 2002/0140336 A1
(43) Pub. Date: Oct. 3, 2002

(54) Coated electrode with enhanced electron emission and ignition characteristics

(76) Inventors: Brian R. Stoner, Chapel Hill, NC (US); Otto Z. Zhou, Chapel Hill, NC (US); Rachel A. Rosen, Chapel Hill, NC (US); William H. Simendinger III, Raleigh, NC (US); Chris Debbaut, Hood River, OR (US)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/817,164

(22) Filed: Mar. 27, 2001

(51) Int. Cl. H01J 1/00; H01J 1/304

(52) U.S. Cl. 313/310

(57) ABSTRACT

An improved electrode capable of smaller variances and mean breakdown voltage, increased breakdown reliability, smaller electron emission turn-on requirements, and stable electron emissions capable of high current densities include a first electrode material, an adhesion-promoting layer disposed on at least one surface of the first electrode material, and a nanostructure-containing material disposed on at least a portion of the adhesion promoting layer. An improved gas discharge device is provided incorporating an electrode formed as described above. An improved circuit incorporating an improved gas discharge tube device as set forth above is also provided. Further, an improved telecommunications network, incorporating an improved gas discharge tube device as set forth above can also be provided. An improved lighting device is also provided incorporating an electrode constructed as described above.

At least some aspects of this invention were made with Government support under contract no. N00014-98-1-05907. The Government may have certain rights in this invention.

### FIELD OF THE INVENTION

The present invention relates to an improved electrode construction and devices including such electrodes. More particularly, the invention relates to an electrode incorporating a nanostructured material, and devices including such electrodes.

### BACKGROUND OF THE INVENTION

In the description that follows references are made to certain compounds, devices and methods. These references should not necessarily be construed as an admission that such compounds, devices and methods qualify as prior art under the applicable statutory provisions.

The term “nano-structured” or “nanostructure” material is used by those familiar with the art to designate materials including nanoparticles with a particle size or less than 100 nm, nanotubes (e.g.—carbon nanotubes), non-carbon nanotubes, nanorods or nanowires (e.g.—Si nanowires with a diameter of approximately 1-100 nm). These types of materials have been shown to exhibit certain properties that have raised interest in a variety of applications.

U.S. Patent No. ______ (Ser. No. 09/259,307 entitled “Nanotube-Based High Energy Material and Method”), the disclosure of which is incorporated herein by reference, in its entirety, discloses the fabrication of carbon-based nanotube materials and their use as a battery electrode material.

U.S. Pat. No. ______ (Ser. No. 09/376,457 entitled “Method for Fabrication of Patterned Carbon Nanotube Films”), the disclosure of which is incorporated herein by reference, in its entirety, discloses a method of fabricating adherent, patterned carbon nanotube films onto a substrate.

U.S. Pat. No. ______ (Ser. No. 09/594,844 entitled “Nanostructure-Based High Energy Material and Method”), the disclosure of which is incorporated herein by reference, in its entirety, discloses a nanostructure material having an intercalated alkali metal. Such materials are described as being useful in certain battery applications.

U.S. Pat. No. ______ (Ser. No. 09/679,303 entitled “X-Ray Generating Mechanism Using Electron Field Emission Cathode”), the disclosure of which is incorporated herein by reference, in its entirety, discloses an X-ray generating device incorporating a nanostructure-containing material.

U.S. Pat. No. ______ (Ser. No. 09/296,572 entitled “Device Comprising Thin Film Carbon Nanotube Electron Field Emitter Structure”) the disclosure of which is incorporated herein by reference, in its entirety, discloses a carbon nanotube-based electron emitter structure.

Gas discharge tubes are devices that typically comprise parallel electrodes in a sealed vacuum chamber containing a noble gas, or mixture of noble gases, at a particular pressure. Gas tubes are designed to be insulators under normal voltage and current conditions. However, under large transient voltages, such as from lightning, a discharge is formed between the electrodes, causing a plasma breakdown of the noble gas(es) inside the chamber. In the plasma state, the gas tube becomes a conductor, which is designed to shunt or short circuit the system in which it is incorporated, thereby protecting other components of the system from damage caused by the over voltage.

Gas discharge tubes are robust, moderately expensive, and have a relatively small shunt capacitance, so bandwidth of high-frequency circuits is not limited as much as by other solid state protectors. Moreover, gas discharge tubes can carry much higher currents than solid state protectors.

However, conventional gas discharge tubes posses certain disadvantages. Gas discharge tubes are unreliable in term of the “mean turn-on voltage”, that is the voltage required to turn the device into a conductor can vary significantly from run to run (i.e.—repeated exposures to overvoltages).

Moreover, since a relatively high electric field is required to cause the plasma breakdown, the electrodes are typically provided with a very small separation distance. Small variations in the gap spacing can cause large variability in the breakdown voltage. Thus, manufacture of such devices must be carried out with great precision in order to avoid such variances.

Thus, it would be advantageous to provide an improved device which exhibits smaller variances in mean turn-on voltage, and can produce a high electric field with less dependence upon a precise, small electrode separation distance.

### SUMMARY OF THE INVENTION

It is an object of the present invention to solve the problems of the art.

It is an object of the invention to provide and improved electrode construction providing smaller variances in mean breakdown voltage; increased breakdown reliability; smaller electron emission turn-on requirements; stable electron emission capable of high current density; and durability.

It is another object to provide an improved gas discharge device exhibiting smaller variances in mean breakdown voltage; increased breakdown reliability; smaller electron emission turn-on requirements; stable electron emission capable of high current density; durability; and reduced dependency on precise manufacture of small electrode separation distances.

It is another object of the invention to provide an improved circuit incorporating a gas discharge device constructed according to the principles of the present invention.

It is a further object of the invention to provide an improved telecommunications network incorporating a gas discharge device constructed according to the principles of the present invention.

It is yet another object of the present invention to provide an improved lighting device incorporating an improved electrode formed according to the principles of the present invention.

More particularly, in one aspect, the present invention is directed to an electrode comprising a first electrode material, an adhesion-promoting layer disposed on at least one surface of the first electrode material, and a nanostructure-containing material disposed on at least a portion of the adhesion-promoting layer.

According to another aspect, the present invention is directed to a gas discharge device comprising a sealed chamber containing at least one noble gas and a plurality of spaced electrodes, at least one electrode comprising a first electrode material, an adhesion-promoting layer disposed on at least one surface of the first electrode material, and a nanostructure-containing material disposed on at least a portion of the adhesion-promoting layer.

According to a further aspect, the present invention is directed to an improved circuit comprising a gas discharge device of the present invention.

According to yet an other aspect, the present invention is directed to an improved telecommunications network comprising a gas discharge device of the present invention.

According to yet another aspect, the present invention is directed to an improved lighting device comprising a first electrode material, an adhesion-promoting layer disposed on at least one surface of the first electrode material, and a nanostructure-containing material disposed on at least a portion of the adhesion-promoting layer.

### BRIEF DESCRIPTION OF THE DRAWING FIGURES

FIG. 1 is a schematic illustration of an improved electrode formed according to the principles of the present invention;

FIG. 2 is a schematic illustration of a gas discharge device formed according to the principles of the present invention;

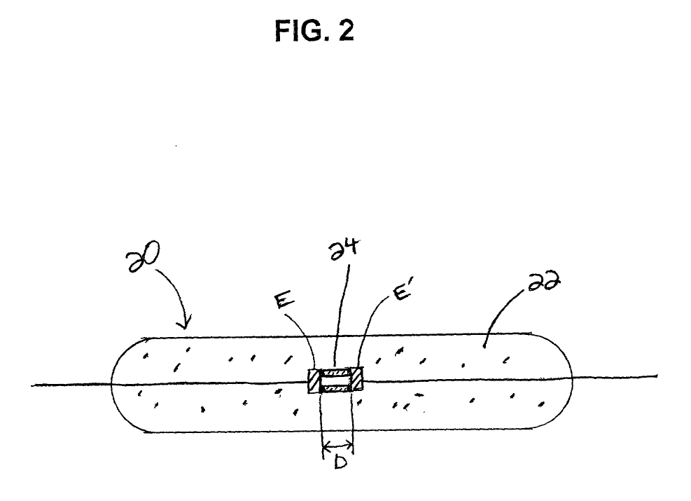

FIG. 3 is a transition electron microscope image of purified single-walled nanotube bundles;

FIG. 4 is a plot of total field emission current vs. applied voltage measured for a device according to the present invention;

FIG. 5 is a plot of mean direct current breakdown voltage and standard deviation vs. argon pressure for a device according to the present invention;

FIG. 6 is a plot of direct current breakdown voltage vs. number of surges for a device of the present invention and for comparative convention devices;

FIG. 7 is a plot of direct current breakdown voltage vs. number of surges for a device according to the present invention;

FIG. 8 is a schematic illustration of an improved circuit formed according to the principles of the present invention;

FIG. 9 is a schematic illustration of a lighting device of the present invention; and

FIG. 10 is an enlarged view of the electrode of FIG. 9.

### DETAILED DESCRIPTION OF THE INVENTION

According to the present invention, an electrode is formed, at least in part, by a nanostructure-containing material. Nanostructure-containing materials are characterized by having basic building blocks that are nanometer-sized in at least one direction. Examples of such basic building blocks include nanoparticles, cage-like fullerene molecules, carbon nanotubes, carbon nanotubes, and silicon nanorods. These basic building blocks can be formed, for example, of carbon, silicon, germanium, aluminum, silicon oxide, germanium oxide, silicon carbide, boron, boron nitride, and boron carbide, etc., or a mixture of such materials.

According to a preferred embodiment of the present invention, the basic building block of the nanostructure-containing material is carbon nanotubes, preferably single-walled carbon nanotubes. These single-walled carbon nanotubes can be formed by what are now considered “conventional” techniques, such as laser ablation, arc-discharge, and chemical vapor deposition techniques. More specific details of such materials and their fabrication can be gleaned, for example, from U.S. Pat. No. ______ (Ser. No. 09/594,844) and U.S. Pat. No. ______ (Ser. No. 09/259,307).

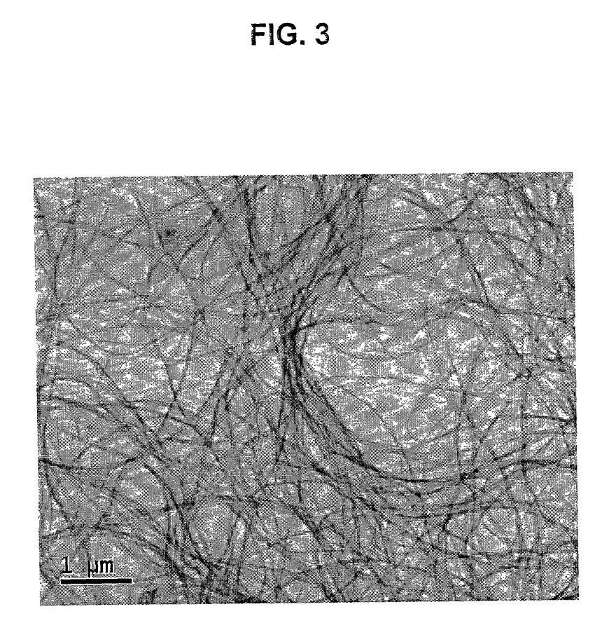

According to a preferred embodiment, single-walled carbon nanotubes having a tube diameter of approximately 1-2 nm, with a bundle diameter of approximately 10-50 nm, were formed using a laser ablation technique. The single-walled carbon nanotubes recovered from laser ablation were then subjected to a suitable purification process. According to a preferred embodiment, the as-recovered material was first subject to reflux in a 20% H₂O₂ solution at 100° C. Then the material was filtered while being suspended in a methanol medium under ultrasonic agitation. The purified single-walled carbon nanotube material was then characterized by transmission electron microscopy and x-ray diffraction measurements. The purified materials were found to contain 80-90 volume % single-walled carbon nanotube bundles with a bundle diameter of 10-50 nm and an average nanotube diameter of approximately 1.4 nm. Impurities found in the material included nickel and cobalt catalysts, amorphous carbon and graphitic nanoparticles. FIG. 3 is a representative transmission electron microscopy micrograph of the purified single walled carbon nanotubes.

In addition to the above described processing steps, it is within the scope of the present invention that the purified materials can be subjected to further processing steps, such as ball milling or oxidation in an acid.

According to the present invention, an electrode is formed, at least in part, by the above-described materials. The electrode can be formed in any suitable manner, and possess any suitable geometry. The electrode may be formed entirely of the nanostructure-containing material of the present invention, or the electrode may comprise a substrate that is at least partially coated with a layer of nanostructure-containing material.

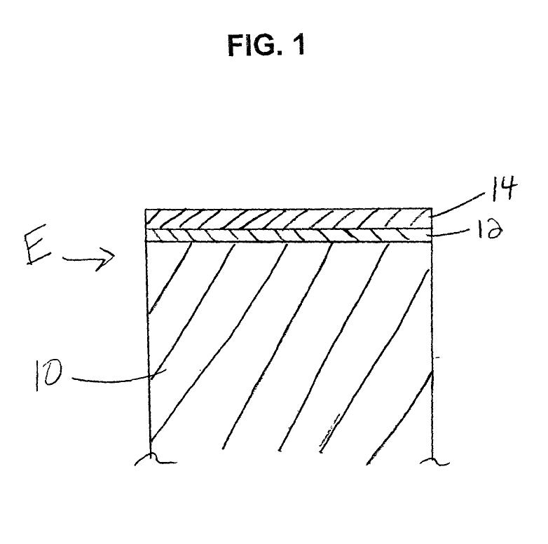

FIG. 1 illustrates a preferred embodiment of an electrode formed according to the principles of the present invention. As illustrated in FIG. 1, the Electrode comprises a first base or substrate material 10, an adhesion-promoting layer 12 formed on at least one surface of the base material 10, and a layer of nanostructure-containing material 14 formed on at least a portion of the adhesion promoting layer 12.

As noted above, the base electrode material 10 can comprise suitable material, and have any suitable geometry. According to a preferred embodiment, the base electrode material 10 comprises molybdenum in the form of a ¾ inch diameter disk.

According to a preferred embodiment, the base electrode material 10 is provided with a thin layer of an adhesion-promoting material formed at least on one surface thereof. Preferably, the adhesion promoting layer 12 comprises a carbon-dissolving, carbide-forming, or low melting point material. Preferred carbon-dissolving materials include nickel, cobalt and iron. Preferred carbide-forming material include silicon, molybdenum, titanium, tantalum, tungsten, niobium, zirconium, vanadium, chromium, and hafnium. Preferred low melting point materials include aluminum, tin, cadmium, zinc and bismuth. The layer 12 can be deposited on the base material 10 by any suitable technique, such as ion sputtering or thermal evaporation. When a material having a relatively high melting point is used, such as platinum, ion sputtering is the preferred technique. When aluminum or iron are chosen as the adhesion-promoting layer material, thermal evaporation is the preferred technique. The adhesion promoting layer 12 can have any suitable thickness. According to a preferred embodiment, the thickness of the adhesion promoting layer 12 is on the order of 50 nm.

Next, a layer of nanostructure-containing material 14 is deposited on at least a portion of the adhesion-promoting layer 12. According to a preferred embodiment, the layer 14 is provided over the entire surface area of the adhesion-promoting layer 12. As previously noted, the layer 14 preferably comprises single-walled carbon nanotubes. The single-walled carbon nanotubes can be deposited by a variety of methods, including suspension or solution casting, spraying, spin coating, sputtering, screen printing, pulsed laser deposition or electrophoretic deposition. By way of example, the film can have a thickness on the order of 0.001 to 50 μm, and more particularly 0.1 to 10 μm. According to a preferred embodiment, the single-walled carbon nanotube layer is sprayed on the adhesion-promoting layer 12.

Preferably, once the base electrode material 10 has been provided with an adhesion-promoting layer 12 and a nanostructure-containing layer 14, the coated electrode E is then subjected to annealing which serves to cure the coatings, thereby increasing the reliability and durability of the coatings. The particular annealing conditions may vary depending on the various materials forming the electrode E. By way of example, illustrative embodiments of the present invention have been prepared by annealing the coated electrode E for 0.5 hours at 5×10⁻⁶ torr vacuum at a temperature ranging from 650-1150° C.

According to a further aspect, the present invention provides an improved gas discharge device 20 which incorporates one or more electrodes E, E′ formed as described above. In the illustrated embodiment, the gas discharge device 20 comprises a sealed chamber 22, containing one or more electrodes E, E′ constructed according to the principles of the present invention. Typically, the sealed chamber contains one or more noble gases at a certain pressure. This pressure may vary in the range of, for example, 0.1-1,000 torr. The electrodes E, E′ are spaced a predetermined distance D from each other. A ceramic spacer 24 may be used to create the proper separation distance D between the electrodes E, E′. In the illustrated embodiment, spacer 24 is cylindrical.

As previously noted, a single electrode of the gas discharge device 20 may be formed according to the principles of the present invention, and the opposing electrode may have a conventional construction. Such an arrangement represents a gas discharge device having a polar construction. A bi-polar gas discharge device can be fabricated by forming each of the plurality of spaced electrodes E, E′ from the same construction according to the principles of the present invention. The separation distance D can vary according to the conditions within the tube, electrode materials, composition of the noble gases, etc. For purposes of illustration, an appropriate separation distance D is 1 mm for a bipolar construction.

As explained in more detail below, a gas discharge device 20 formed according to the principles of the present invention possesses several advantages over conventional devices. Namely, the gas discharge device 20 exhibits smaller variances and mean breakdown voltage, increased breakdown reliability, smaller electron emission turn-on voltage requirement, stable electron emission at high current densities, less dependence upon precise electrode separation distance, and overall improvements in reliability and durability.

In order to demonstrate the effectiveness of the present invention, exemplary embodiments were constructed and analyzed. The following discussion of these exemplary embodiments are for purposes of illustration, and should not be viewed as limiting the scope of the present invention.

Raw single-walled carbon nanotube materials were fabricated using a laser-ablation system. The raw materials were purified first by reflux in 20% H₂O₂ solution at 100° C., then filtered in methanol under the assistance of ultrasonic agitation. The filtered single-walled carbon nanotube materials were then dried under a 10⁻⁶ torr vacuum. The purified material was found to contain 80-90 volume % single-walled nanotube bundles, with a bundle diameter of 10-50 nm, and an average nanotube diameter of 1.4 nm. Impurities included nickel and cobalt catalyst, and graphitic nanoparticles.

Molybdenum electrodes in the form of ¾ inch diameter disks were then coated with a thin layer, having a thickness on the order of 50 nm, of an adhesion-promoting material. A first set of molybdenum electrodes were coated. A first electrode was provided with a coating of aluminum, a second electrode was coated with iron, and a third electrode was coated with platinum. These electrodes were then coated with a thin layer of single-walled carbon nanotube material. The first coated electrode was annealed for 0.5 hours at 5×10⁻⁶ torr vacuum at 650° C. The second coated electrode was annealed for 0.5 hours at 5×10⁻⁶ torr vacuum at 850° C. The third coated electrode was annealed for 0.5 hours at 5×10⁻⁶ torr vacuum at 1150° C.

Next, a second set of electrodes were prepared. A fourth electrode was coated with aluminum, a fifth electrode was coated with iron, and a sixth electrode was coated with platinum. These electrodes were then coated within a thin layer of single-walled carbon nanotube material. The fourth, fifth and sixth coated electrodes were not subjected to annealing. Measurements were then taken on both the annealed and unannealed samples.

Electron field emission properties were then measured using the above described nanotube-coated electrode separated by a distance of approximately 500 microns from a parallel plain molybdenum electrode. In this arrangement, the nanotube-coated electrodes act as the cathode, and the plain molybdenum electrode acts as the anode. The above described electrodes were placed under a vacuum of 10⁻⁶ torr.

Bipolar gas discharge devices were also fabricated using the same coated electrodes as both the cathode and anode. The distance between the electrodes was fixed at approximately 1 mm by a ceramic spacer. The sealed chamber of the discharge device was filled with noble gases and sealed. The direct current breakdown voltage was then measured over 1000 voltage surges. For purposes of comparison, commercially available gas discharge tubes with the same electrode to electrode separation distance were also measured.

Electron field emission data was collected using the above-described parallel-plate configuration in which the nanotube-coated electrode operates as the cathode, and the plane molybdenum electrode acts as the anode. The fixed anode-cathode distance is 500 microns.

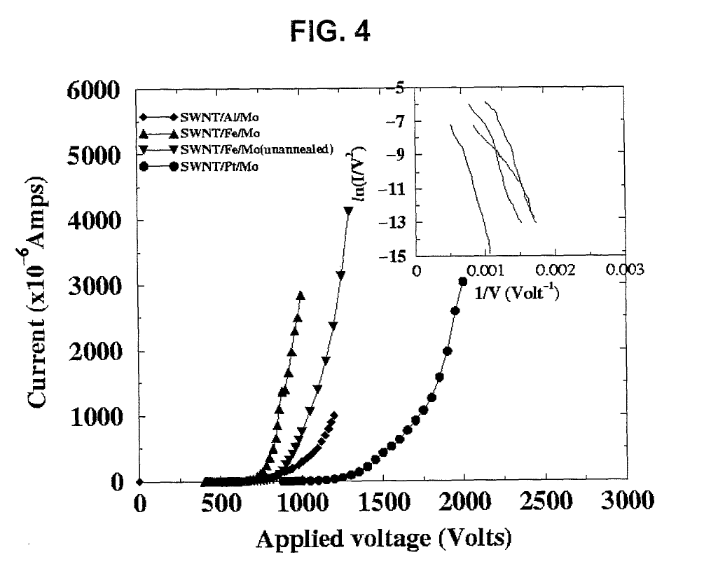

As illustrated in FIG. 4, the electron emission turn-on voltage, defined as the voltage for a total emission current of 1 μA collected over an emission area of 2.8 cm², is approximately 600 V (1.2 V/micron) for an annealed electrode having an iron adhesion-promoting layer as well as the annealed electrode having an aluminum adhesion-promoting layer. The emission turn-on voltage for the unannealed electrode having an iron adhesion-promoting layer was approximately 660 V (1.3 V/micron), while the emission turn-on voltage was approximately 1260 V (2.5 V/micron) for the annealed electrode having a platinum adhesion-promoting layer.

As shown in the inset of FIG. 4, the data was plotted as In (I/V²) versus I/V (the “Fowler-Nordheim” plot). As illustrated in FIG. 4, the data, as plotted, is found to be essentially linear, thereby confirming that the nanotube-coated electrodes were field-emitting electrons under applied electrical fields.

The critical electrical field for a 1 mA/cm² current density was also measured and found to be 1.7 V/micron for the annealed electrode having an iron adhesion-promoting layer, 2.3 V/micron for the annealed electrode having an aluminum adhesion-promoting layer, 2.0 V/micron for the unannealed electrode having an iron adhesion-promoting layer, and 3.0 V/micron for the annealed electrode having a platinum adhesion-promoting layer.

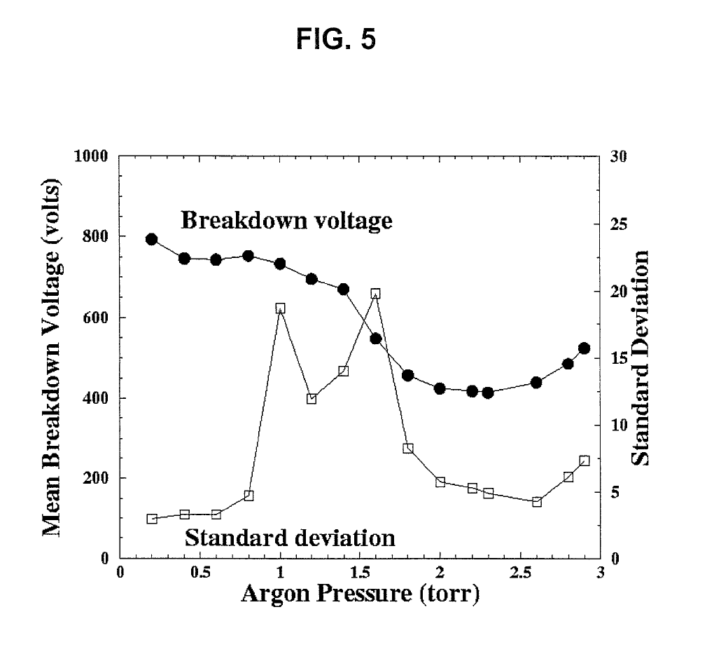

Direct current breakdown voltage measurements were then taken for a bipolar gas discharge device comprising spaced molybdenum electrodes provided with an iron adhesion-promoting layer and a layer of single walled carbon nanotubes. Measurements were taken at different gas pressures within the device, and with different gas contents. The results are summarized in FIG. 5. The measurements were taken over 100 voltage surges performed at each argon pressure data point. As illustrated in FIG. 5, direct current breakdown voltage varies with the gas pressure within the sealed chamber. The most reliable breakdown behavior was observed at 0.5 torr using an argon gas. The breakdown voltage was lower at higher argon pressures, and was observed to be even lower when a small amount of neon gas was added.

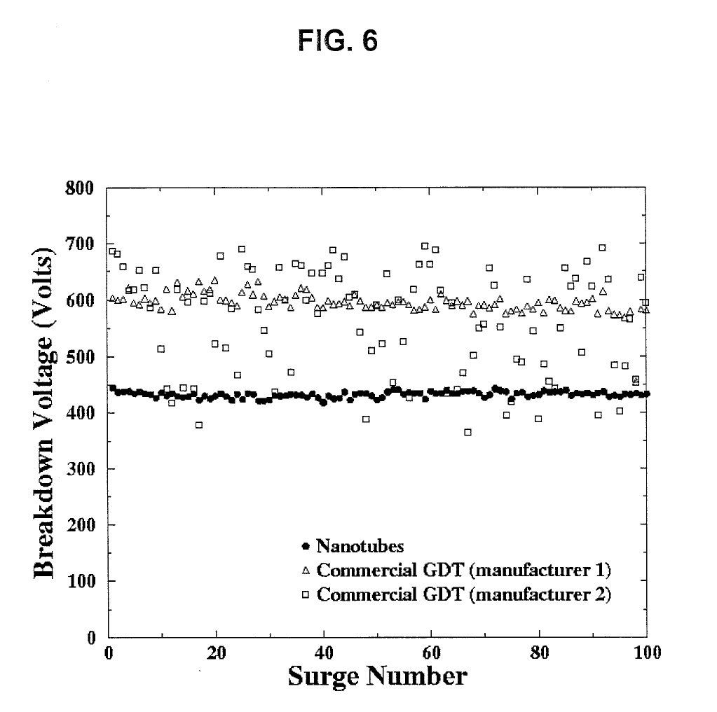

Reliability testing was also performed on a gas discharge device comprising a pair of spaced parallel electrodes comprising the previously mentioned molybdenum disk provided with an adhesion promoting layer of iron and a coating of single-walled carbon nanotubes. The sealed chamber of the device was filled with 15 torr argon, with neon added, and with a 1 mm separation distance defined between the electrodes. For purposes of comparison, a first and second commercially available gas discharge tube were also measured. The commercially available gas discharge tubes had the same electrode-electrode separation distance. FIG. 6 illustrates the direct current breakdown voltage measured over 100 voltage surges for the nanotube-based gas discharge device of the present invention, as well as the comparative commercially available gas discharge devices. As illustrated in FIG. 6, the nanotube-based gas discharge device of the present invention had a breakdown voltage of 448.5 V, and a standard deviation of 4.58 V after 100 surges. The commercially available gas discharge device from the first manufacturer had a higher breakdown voltage of 594 V with a greater standard deviation of 20 V, while the gas discharge device from the second manufacturer also had a higher direct current breakdown voltage of 563 V with a greater standard deviation of 93 V. Thus, it is apparent that the breakdown reliability of the nanotube-based gas discharge device of the present invention is 420 times better, and the necessary breakdown voltage is approximately 30% lower, when compared with the two commercially available gas discharge devices.

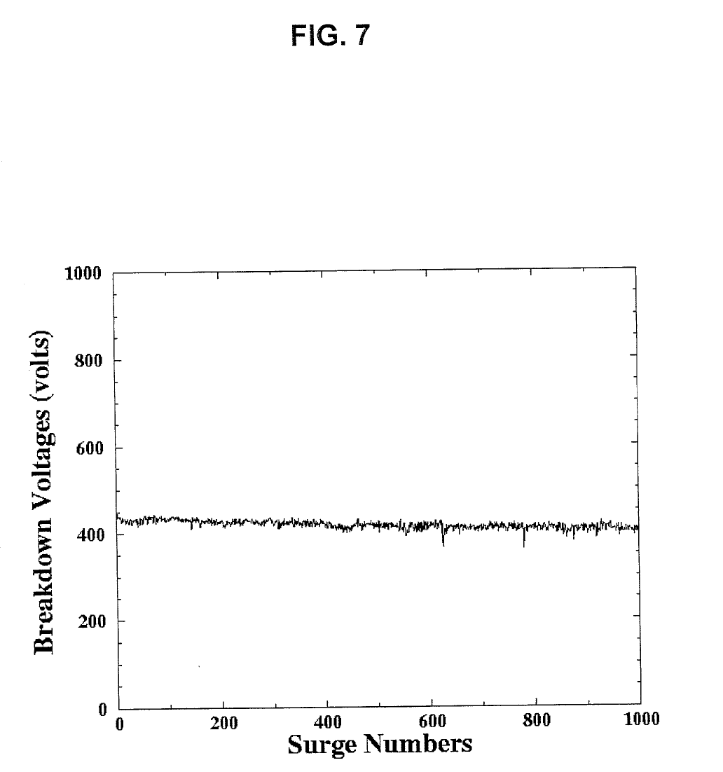

FIG. 7 is a plot of direct current breakdown voltages measured over 1000 surges for the same gas discharge device of the present invention described above in connection with the measurements taken and illustrated in FIG. 6. As illustrated in FIG. 7, the breakdown voltage decreased gradually with an increasing number of surges. This is a desirable property, since the amount of over voltage in a circuit in which the gas discharge device may be employed, is reduced over time, thereby improving the protection of other circuit components from an over voltage condition. After 1000 surges, the direct current breakdown voltage of the gas discharge device of the present invention became approximately 400 V. Thus, the gas discharge device constructed according to the principles of the present invention possesses an improved reliability when compared with conventional devices.

This gradual decrease in the breakdown voltage is a desirable property of the present invention. Typically, conventional gas discharge devices exhibit the opposite behavior. Namely, the breakdown voltage usually increases over time, thereby adversely effecting the reliability of the device. By contrast, the present invention, by exhibiting a decreased breakdown voltage over time, providing important advantages in terms of reliability of the device, and its ability to protect associated circuit components from over voltages.

Measurements were also taken for unannealed electrodes. After 1000 surges, the nanotube-based electrodes were removed from the devices and were examined by a scanning electron microscope. The unannealed electrodes were depleted of the single walled carbon nanotubes, while the majority of nanotubes remained intact on the annealed electrodes. The degradation of unannealed electrodes is believed to be caused by the pulling off of single walled carbon nanotubes under the high electrical fields present in such devices. Thus, it appears that by providing an adhesion-promoting layer, and annealing the coated electrode, the present invention remains stable and robust even after being exposed repeatedly to high electrical fields.

To summarize the above, the collected data clearly shows the gas discharge devices constructed according to the principles of the present invention have significantly improved performance in terms of direct current breakdown voltage and reliability when compared to similarly constructed commercially available gas discharge devices. The lower required breakdown voltage, and a 420 times reduction in breakdown voltage fluctuations make the gas discharge devices of the present invention attractive over voltage protection units.

Thus, it is within the scope of the present invention to provide a circuit, comprising at least one gas discharge device formed according to the principles of the present invention.

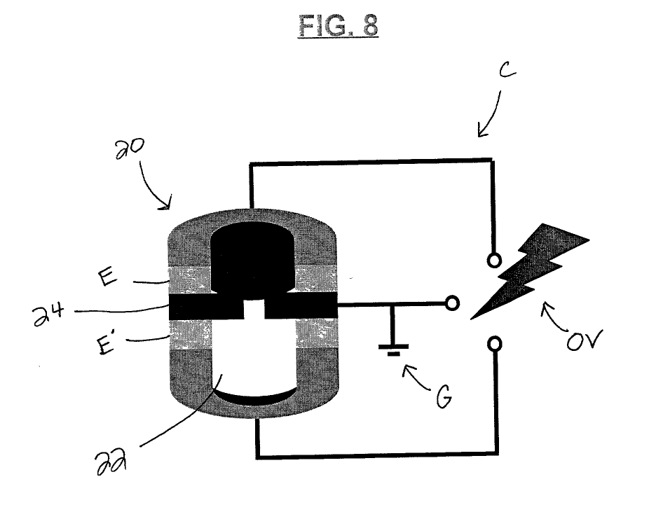

Such a circuit C is schematically illustrated in FIG. 8. As illustrated in FIG. 8, upon introduction of an overvoltage OV, the electrodes E, E′ field emit electrons sufficient to cause a plasma breakdown within the chamber 22 of the gas discharge device 20. This breakdown causes the gas discharge device 20 to become conductive thereby defining a conductive path for the overvoltage OV leading to the ground G. Thus, the overvoltage OV can be directed to the ground, and away from other sensitive components of the circuit (not shown).

Further, according to the principles of the present invention, an improved telecommunications network can be provided. Examples of suitable telecommunications networks, incorporating a gas discharge protection device constructed according to the principles of the present invention include asymmetric digital subscriber lines (ADSL) and high-bit-rate digital subscriber lines (HDSL).

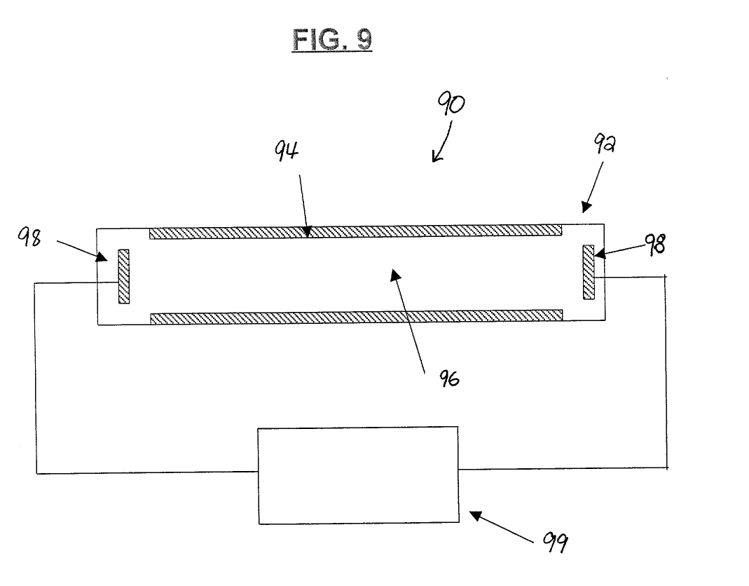

The nanotube-based electrodes according to the present invention, by virtue of their improved properties, such as reduced variance and mean breakdown voltage, increased breakdown reliability over time, smaller electron emission turn-on requirements, stable electron emissions capable of high current density, and decreased reliance upon precise small separation distances when incorporated into certain devices, render them especially suited in other applications requiring robust and reliable ignition. For instance, electrodes constructed according to the principles of the present invention may be incorporated in a lighting device, such as high intensity lighting. FIG. 9 is a schematic illustration of an exemplary lighting device in which one or more electrodes constructed according to the principles of the present invention may be incorporated. FIG. 9 illustrates lighting device 90 which generally comprises a filled glass tube 92 which includes a phosphor coating 94 disposed on an inner surface thereof, Chamber 96 defined within the glass tube 92 contains a suitable material such as mercury and one or more inert gas. One or more electrodes 98 formed according to the principles of the present invention, as set forth previously, are provided and are in communication with a power source 99. The power source 99 causes the electrodes 98 to field emit electrons, thereby exciting the materials and phosphor coating within the glass tube 92 in a manner familiar to those in the art.

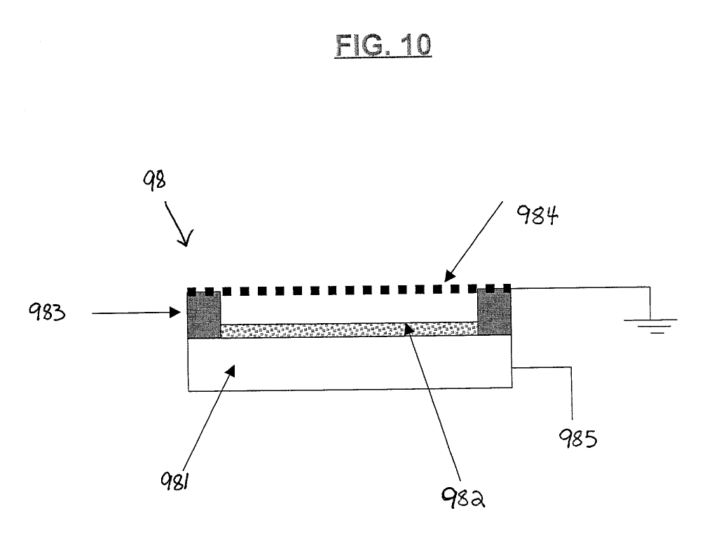

FIG. 10 is an enlarged schematic illustration of the electrode 98 of the lighting device 90. As illustrated in FIG. 10, electrode 98 generally comprises a substrate 981 upon which coating 982 is applied. As previously described, coating 982 can comprise a nanostructure-containing material according to the present invention, as well as an adhesion promoting layer. According to a preferred embodiment, the nanostructure-containing material comprises single walled carbon nanotubes. An electrical insulator 983 is provided on the substrate 981, and includes a gate structure 984 which is in communication with the ground. By virtue of the beneficial properties of the electrodes of the present invention, the need for ballast-type igniters can be eliminated.

Although the present invention has been described in connection with the preferred embodiments thereof, it will be appreciated by those skilled in the art that editions, deletions, modifications and substitutions not specifically described above may be made without departure from the spirit and scope of the invention as defined in the appended claims.

What is claimed is:

1. An electrode comprising a first electrode material, an adhesion-promoting layer disposed on at least one surface of the first electrode material, and a nanostructure-containing material disposed on at least a portion of the adhesion-promoting layer.

2. The electrode of claim 1, wherein the electrode is a gas discharge device electrode.

3. The electrode of claim 1, wherein the first electrode material is molybdenum.

4. The electrode of claim 4, wherein the adhesion promoting interlayer has a thickness of approximately 10-1,000 nm.

5. The electrode of claim 1, wherein the adhesion-promoting layer comprises a metallic material.

6. The electrode of claim 1, wherein the adhesion-promoting layer comprises a carbon-dissolving, carbide forming, or low melting point material.

7. The electrode of claim 5, wherein the metallic material comprises: Ni, Co, Fe, Si, Mo, Ti, Ta, W, Nb, Zr, V, Cr, Hf, Al, Sn, Cd, Zn, or Bi.

8. The electrode of claim 1, wherein the nanostructure-containing material comprises carbon nanotubes.

9. The electrode of claim 8, wherein the carbon nanotubes comprise single-walled carbon nanotubes.

10. The electrode of claim 1, wherein the nanostructure-containing material is formed from: carbon, silicon, germanium, aluminum, silicon oxide, germanium oxide, silicon carbide, boron, boron nitride, boron carbide, or a mixture thereof.

11. The electrode of claim 1, wherein the electrode is annealed.

12. The electrode of claim 1, wherein the electrode has a turn-on voltage required to produce an emitted electron current of approximately 1 μA over an emission area of approximately 2.8cm² of approximately 1.2 V/micron 2.5 V/micron.

13. The electrode of claim 1, wherein the electrode has a critical electric field of approximately 1.7 V/micron-3.0 V/micron to produce a current density of approximately 1.7 mA/cm².

14. The electrode of claim 8, wherein the nanostructure-containing material covers the entire adhesion-promoting layer.

15. A gas discharge device comprising a sealed chamber containing at least one noble gas and a plurality of spaced electrodes, at least one electrode comprising a first electrode material, an adhesion-promoting layer disposed on at least one surface of the first electrode material, and a nanostructure-containing material disposed on at least a portion of the adhesion-promoting layer.

16. The device of claim 15, wherein the first electrode material is molybdenum.

17. The device of claim 15, wherein the adhesion promoting layer has a thickness of approximately 10-1,000 nm and the nanostructure-containing layer has a thickness of approximately 1-100 μm.

18. The device of claim 15, wherein the adhesion-promoting layer comprises a metallic material.

19. The device of claim 15, wherein the adhesion-promoting layer comprises a carbon-dissolving, carbide forming, or low melting point material.

20. The device of claim 18, wherein the metallic material comprises Ni, Co, Fe, Si, Mo, Ti, Ta, W, Nb, Zr, V, Cr, Hf, Al, Sn, Cd, Zn, or Bi.

21. The device of claim 15, wherein the nanostructure-containing material comprises single-walled carbon nanotubes.

22. The device of claim 15, wherein the electrode is annealed.

23. The device of claim 15, wherein the electrode has a turn-on voltage required to produce an emitted electron current of approximately 1 μA over an emission area of approximately 2.8 cm² of approximately 1 .2 V/micron 2.5 V/micron.

24. The device of claim 15, wherein the electrode has a critical electric field of approximately 1.7 V/micron-3.0 V/micron to produce a current density of approximately 1 A/cm² .

25. The device of claim 21, wherein the nanostructure-containing material covers the entire adhesion-promoting layer.

26. The device of claim 15, wherein each of the plurality of electrodes comprise the first electrode material, the adhesion-promoting layer disposed on at least one surface of the first electrode material, and the nanostructure-containing material disposed on at least a portion of the adhesion-promoting layer.

27. The device of claim 15, wherein the spaced electrodes define a separation distance of approximately 0.1-1.0 mm.

28. The device of claim 27, wherein the separation distance is approximately 1 mm.

29. The device of claim 27, wherein the separation distance is created by a ceramic spacer.

30. The device of claim 15, wherein the sealed chamber contains at least one inert gas at a pressure of 0.5-800 torr.

31. The device of claim 30, wherein the sealed chamber contains argon gas at a pressure of approximately 0.5 torr.

32. The device of claim 15, wherein the device exhibits a mean breakdown voltage of approximately 448.5 V with a standard deviation of 4.58 V measured over 100 surges.

33. The device of claim 15, wherein the device exhibits a breakdown voltage of approximately 400 V after being exposed to 1000 surges.

34. A circuit comprising at least one of an interface device box and a central office switching gear, the circuit further comprising at least one gas discharge device as set forth in claim 15.

35. A telecommunications network comprising a gas discharge device as set forth in claim 15.

36. The network of claim 35, further comprising at least one of an interface device box and a central office switching gear.

37. The network of claim 35, wherein the network comprises an asymmetric digital subscriber line.

38. The network of claim 35, wherein the network comprises a high-bit-rate digital subscriber line.

39. A lighting device comprising a sealed chamber containing an excitable gas and at plurality of spaced electrodes, at least one of said electrodes comprising a first electrode material, an adhesion-promoting layer disposed on at least one surface of the first electrode material, and a nanostructure-containing material disposed on at least a portion of the adhesion-promoting layer.

40. The lighting device of claim 39, wherein the nanostructure-containing material comprises single-walled carbon nanotubes.

41. The lighting device of claim 40, wherein the adhesion-promoting layer comprises a carbon-dissolving, carbide forming, or low melting point material.

42. A method of providing a gas discharge device with smaller variances in mean breakdown voltage, increased breakdown reliability, smaller electron emission turn-on requirements, and stable electron emission at high current density, the gas discharge device comprising a sealed chamber containing at least one noble gas and a plurality of spaced electrodes, the method comprising:
applying an adhesion-promoting layer to a surface of at least one of the plurality of electrodes; and
applying a layer of nanostructure-containing material on to at least a portion of the adhesion-promoting layer.

43. The method of claim 42, further comprising the step of annealing the coated electrode.

44. The method of claim 43, wherein the step of annealing is carried out over a period of approximately 0.5 hr. at a pressure of approximately 5×10-6 Torr at a temperature of approximately 650-1150° C.

45. The method of claim 42, wherein the nanostructure-containing material comprises single-walled carbon nanotubes.

46. The method of claim 42, wherein the adhesion-promoting layer comprises a carbon-dissolving, carbide forming or low melting point material.

47. The method of claim 46, wherein the adhesion-promoting layer comprises: Ni, Co, Fe, Si, Mo, Ti, Ta, W, Nb, Zr, V, Cr, Hf, Al, Sn, Cd, Zn, or Bi.

48. The method of claim 42, wherein the method comprises applying the adhesion-promoting layer and nanostructure-containing layer to each of the plurality of electrodes.

49. The method of claim 42, wherein the nanostructure-containing material coves the entire adhesion-promoting layer.

50. The method of claim 42, wherein the adhesion-promoting layer has a thickness of approximately 10-100 nm and the nanostructure-containing layer has a thickness of approximately 1-100 μm.

51. The method of claim 42, wherein the at least one electrode is formed of molybdenum.
